(19) United States
(12) Patent Application Publication
(10) Pub. No.: US 2026/0086509 A1
(43) Pub. Date: Mar. 26, 2026

(54) OFFLINE SIMULATION DEVICE

(71) Applicant: FANUC CORPORATION, Minamitsuru-gun, Yamanashi (JP)

(72) Inventor: Toshiyuki ANDO, Yamanashi (JP)

(21) Appl. No.: 19/111,043

(22) PCT Filed: Oct. 5, 2022
(86) PCT No.: PCT/JP2022/037236

§ 371 Date: Mar. 12, 2025

(51) Int. Cl. G05B 13/02

(52) U.S. Cl. CPC G05B 13/0205

(57) ABSTRACT

This offline simulation device includes an offline program execution unit that executes a robot program in an offline simulation environment in which a robot, a plurality of workpieces that are stacked for the robot to extract, and a vision sensor for detecting the plurality of workpieces are disposed in a virtual space, so as to perform simulation of actions of the robot extracting the workpieces, and an automatic path generation execution unit that copies the offline simulation environment, and generates an action path for the actions of the robot in a duplicated offline simulation environment that has been copied. The offline simulation device also includes an adjustment unit that performs editing of the robot program and/or adjustment of parameters of the action path, on the basis of the actions of the robot that have been simulated and the action path that has been generated.

### TECHNICAL FIELD

The present invention relates to an offline simulation device that performs simulation of an operation of a robot and generation of an operation path offline.

### BACKGROUND ART

There is a desire to confirm the layout, the set-up, and the operation of the robot system offline, and then to complete the start-up work in the field in a short time. For this reason, offline programming tools have been prepared.

Further, there is automatic path generation in which an operation path of a robot is automatically generated. In the path generation, the same system as that in a real space is prepared in a virtual space, a path is generated in the virtual space, and the successfully generated path is sent to a robot control device to operate the robot.

For example, a technology is known which extracts a welding line based on a three-dimensional CAD file in which three-dimensional shape information of a work object is stored, automatically generates a work operation path for a welding line in which a teaching-less function is selected for each welding line, and compensates for a work operation path using an offline teaching function for a work line in which interference occurs in an overall path simulation function. For example, refer to Patent Document 1.

### CITATION LIST

### Patent Document

Patent Document 1: Japanese Unexamined Patent Application, Publication No. 2000-190264

### DISCLOSURE OF THE INVENTION

### Problems to be Solved by the Invention

However, in the related art, since there is only one offline simulation environment in which the robot, the workpiece, and the like are arranged in the virtual space, it is difficult to simultaneously execute the execution of the robot program and the generation of the operation path of the robot in the offline simulation environment, for example, in a depalletization system for cardboard boxes, etc. or picking of a bulk pile of workpieces.

Therefore, it has been desired to simultaneously execute the operation of a robot by executing a robot program offline and the generation of the operation path of the robot by automatic path generation.

### Means for Solving the Problems

In an aspect according to the present disclosure, an offline simulation device includes an offline program execution unit configured to execute a robot program in an offline simulation environment in which a robot, a plurality of workpieces piled to be taken out by the robot, and a vision sensor that detects the plurality of workpieces are arranged in a virtual space, and simulate an operation of the robot taking out each of the plurality of workpieces, an automatic path generation execution unit configured to copy the offline simulation environment and generate an operation path of the operation of the robot in a replicated offline simulation environment obtained by copying, and an adjustment unit configured to compensate for the robot program and/or adjust a parameter of the operation path based on a simulated operation of the robot and a generated operation path.

In another aspect according to the present disclosure, an offline simulation device includes an offline program execution unit configured to execute a robot program in an offline simulation environment in which a robot, a plurality of workpieces piled to be taken out by the robot, and a vision sensor that detects the plurality of workpieces are arranged in a virtual space, and simulate an operation of the robot taking out each of the plurality of workpieces, an automatic path generation execution unit configured to generate an operation path of the operation of the robot in the offline simulation environment, a storage unit configured to store an execution state of the robot program in the offline simulation environment by the offline program execution unit and an execution state of generation of the operation path in the offline simulation environment by the automatic path generation execution unit, and an adjustment unit configured to compensate for the robot program and/or adjust a parameter of the operation path based on a simulated operation of the robot and a generated operation path.

### BRIEF DESCRIPTION OF THE DRAWINGS

FIG. 1 is a diagram showing an example of a configuration of a robot system according to a first embodiment;

FIG. 2 is a functional block diagram showing a functional configuration example of an offline simulation device according to the first embodiment;

FIG. 3 is a flowchart showing offline processing of the offline simulation device;

FIG. 4 is a functional block diagram showing a functional configuration example of an offline simulation device according to a second embodiment; and

FIG. 5 is a flowchart showing offline processing of the offline simulation device.

### PREFERRED MODE FOR CARRYING OUT THE INVENTION

### First Embodiment

First, an outline of the present embodiment will be described. In the present embodiment, the offline simulation device executes a robot program in an offline simulation environment in which a robot, a plurality of piled workpieces to be taken out by the robot, and a vision sensor that detects the plurality of workpieces are arranged in a virtual space, and simulates an operation of the robot to take out the workpieces. Further, the offline simulation device copies the offline simulation environment and generates an operation path of the robot in the replicated offline simulation environment obtained by copying. The offline simulation device compensates for the robot program and/or adjusts the parameters of the path generation, based on the simulated robot operation and the generated path.

Thus, according to the present embodiment, it is possible to simultaneously execute the operation of the robot by executing the robot program and the generation of the operation path of the robot by automatic path generation offline.

The outline of the present embodiment has been described above.

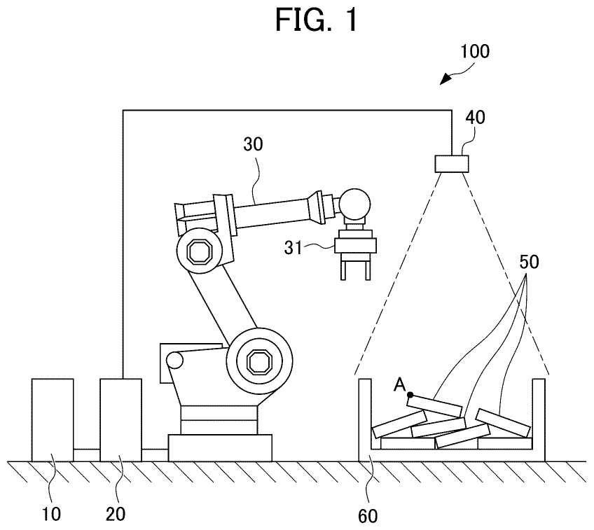

FIG. 1 is a diagram showing an example of a configuration of a robot system 100 according to a first embodiment.

As shown in FIG. 1, the robot system 100 includes an offline simulation device 10, a robot control device 20, a robot 30, a vision sensor 40, a plurality of workpieces 50, and a container 60.

The offline simulation device 10, the robot control device 20, the robot 30, and the vision sensor 40 may be directly connected to each other via a connection interface (not shown). The offline simulation device 10, the robot control device 20, the robot 30, and the vision sensor 40 may be connected to each other via a network (not shown) such as a local area network (LAN) or the Internet. In this case, the offline simulation device 10, the robot control device 20, the robot 30, and the vision sensor 40 each include a communication unit (not shown) communicating with each other through such connection. To facilitate explanation, FIG. 1 illustrates the offline simulation device 10 and the robot control device 20 independently of each other, and the offline simulation device 10 in this case may be configured by, for example, a computer. However, the present invention is not limited to such a configuration and, for example, the offline simulation device 10 may be mounted inside the robot control device 20 and may be integrated with the robot control device 20.

The robot control device 20 is a device known to those skilled in the art for controlling the operation of the robot 30. The robot control device 20 generates a control signal for controlling the operation of the robot 30 so as to take out the workpieces 50, for example, based on the take-out positional information of the workpieces 50 detected by the vision sensor 40 described later, among the workpieces 50 piled in bulk. Then, the robot control device 20 outputs the generated control signal to the robot 30.

The robot 30 is a robot that operates under the control of the robot control device 20. The robot 30 includes a base portion for rotating about a vertical axis, an arm for moving and rotating, and a take-out hand 31 attached to the arm for holding the workpiece 50. In FIG. 1, a grasping type take-out hand is attached to the take-out hand 31 of the robot 30, but an air suction type take-out hand may be attached, or a magnetic hand that takes out an iron workpiece by magnetic force may be attached.

Peripheral devices such as a conveyor to which the taken-out workpiece 50 is transferred are not shown. Since a specific configuration of the robot 30 is well known to those skilled in the art, a detailed description thereof will be omitted.

The offline simulation device 10 and the robot control device 20 associate the machine coordinate system for controlling the robot 30 with the camera coordinate system of the vision sensor 40 indicating the take-out position of the workpieces 50 by calibration performed in advance.

The vision sensor 40 is a three-dimensional measuring device such as a stereo camera, and acquires three-dimensional information (hereinafter, also referred to as a “distance image”) in which a value converted from a distance between a plane perpendicular to the optical axis of the vision sensor 40 and each point of the surface of the workpiece 50 piled in bulk in the container 60 is a pixel value. For example, as shown in FIG. 1, the pixel value of the point A of the workpiece 50 on the distance image is a value obtained by converting from the distance between the vision sensor 40 and the point A of the workpiece 50 in the Z-axis direction of the three-dimensional coordinate system (X, Y, Z) of the vision sensor 40. That is, the Z-axis direction of the three-dimensional coordinate system is the optical axis direction of the vision sensor 40. Further, the vision sensor 40 may be configured to acquire three-dimensional point group data of a plurality of workpieces 50 loaded in the container 60 by, for example, a stereo camera.

In addition, the vision sensor 40 may acquire a two-dimensional image such as a grayscale image or an RGB image together with the distance image. The vision sensor 40 may be a digital camera or the like.

The workpieces 50 are randomly placed in the container 60 including a state in which they are piled in bulk. The shape and the like of each of the workpieces 50 are not particularly limited as long as the workpieces can be held by the take-out hand 31 attached to the arm of the robot 30.

The workpieces 50 may be provided for a depalletization system such as cardboard boxes stacked on a pallet.

### <Offline Simulation Device 10>

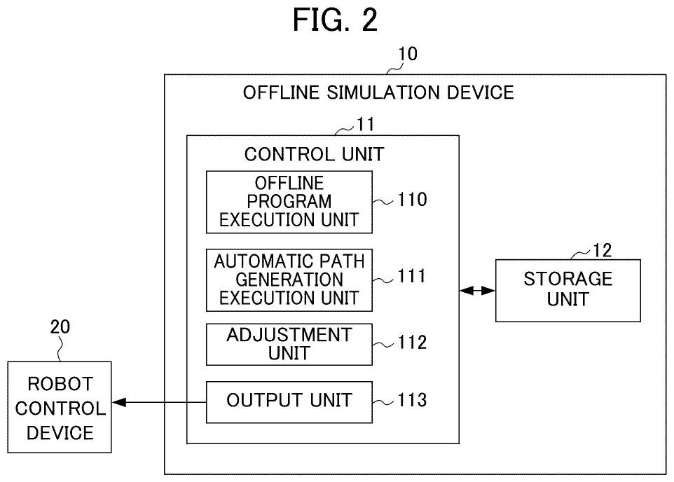

FIG. 2 is a functional block diagram showing a functional configuration example of the offline simulation device 10 according to the first embodiment.

The offline simulation device 10 is a computer known to those skilled in the art, and includes a control unit 11 and a Storage unit 12, as shown in FIG. 2. Further, the control unit 11 includes an offline program execution unit 110, an automatic path generation execution unit 111, an adjustment unit 112, and an output unit 113.

### <Storage 12>

The storage unit 12 is a solid state drive (SSD), a hard disk drive (HDD), or the like, and may store a robot program, an automatic path creation program, or the like.

In addition, the storage unit 12 stores an offline simulation environment in which the robot 30, the vision sensor 40, the workpieces 50, and the three-dimensional model (for example, CAD data or the like) of the container 60 illustrated in FIG. 1 arranged in the virtual space are operated, by the offline program execution unit 110 to be described later executing the robot program offline. In addition, the storage unit 12 stores a replicated offline simulation environment in which an offline simulation environment is copied in order for the automatic path generation execution unit 111, which will be described later, to generate a path of the operation of the robot 30 based on a path generation request from the offline program execution unit 110.

With such a configuration, it is possible for the offline simulation device 10 to simultaneously execute the operation of the robot by executing the robot program and the generation of the operation path of the robot by automatic path generation offline.

In addition, in the offline simulation environment and the replicated offline simulation environment, a three-dimensional model of a peripheral device (not shown) of the robot system 100 may be arranged.

### <Control Unit 11>

The control unit 11 includes a CPU, ROM, RAM, CMOS memory, and the like, which are configured to communicate with each other via a bus, and are known to those skilled in the art.

The CPU is a processor that generally controls the offline simulation device 10. The CPU reads the system program and the application program stored in the ROM via the bus, and controls the entire offline simulation device 10 in accordance with the system program and the application programs. Accordingly, as illustrated in FIG. 1, the control unit 11 is configured to realize the functions of the offline program execution unit 110, the automatic path generation execution unit 111, the adjustment unit 112, and the output unit 113. The RAM stores various data such as temporary calculation data and display data. The CMOS memory is configured as nonvolatile memory which is backed up by a battery (not shown), and in which the storage state is maintained even when the power of the offline simulation device 10 is turned off.

For example, the offline program execution unit 110 executes a robot program in an offline simulation environment in which the robot 30, the vision sensor 40, the workpiece 50, and the container 60 are arranged in the virtual space, and simulates an operation in which the robot 30 takes out the workpieces 50.

Specifically, for example, the offline program execution unit 110 executes the robot program by receiving an execution instruction of the robot program offline from the user via an input device (not illustrated) such as a keyboard or a touch screen. The offline program execution unit 110 outputs a path generation request of an operation path of the robot 30 in the offline simulation environment to the automatic path generation execution unit 111 to be described later, in order to cause the robot 30 to take out the workpieces 50 detected from the virtual image generated by the vision sensor 40 in the offline simulation environment based on the robot program. In addition, the path generation request includes positional information of the workpieces 50 to be taken out in the offline simulation environment.

The offline program execution unit 110 operates the robot 30 and takes out the workpieces 50 in the offline simulation environment, based on the path generated by the automatic path generation execution unit 111. Then, in the offline simulation environment, the offline program execution unit 110 executes the robot program until the robot 30 takes out all the workpieces 50 detected from the virtual image by the vision sensor 40.

In addition, the offline program execution unit 110 may terminate the execution of the robot program by determining that the robot 30 and the hand cannot take out the workpieces 50 due to the interference with a three-dimensional model of a peripheral device (not shown) of the robot system 100, in the calculation of the take-out positions of the workpieces 50.

For example, when a path generation request is received from the offline program execution unit 110, the automatic path generation execution unit 111 copies the offline simulation environment and generates a path of the operation of the robot 30 in a replicated offline simulation environment obtained by copying.

Specifically, the automatic path generation execution unit 111 executes, for example, an automatic path generation program, and generates an operation path for the robot 30 to take out the workpieces 50 in the replicated offline simulation environment, based on the positional information of the workpieces 50 to be taken out included in the path generation request, by using a known path generation method. In addition, the generated operation path may be generated such that the robot 30 and the hand do not interfere with the three-dimensional model of the container 60 and a peripheral device (not shown) in the replicated offline simulation environment. In addition, the generated operation path may include a path from when the robot 30 takes out the workpieces 50 to when the robot 30 moves to a peripheral device (not shown) such as a conveyor in the replicated offline simulation environment.

The automatic path generation execution unit 111 outputs the generated operation path to the offline program execution unit 110.

The adjustment unit 112 compensates for the robot program and/or adjusts the parameters of the operation path based on, for example, the operation of the robot 30 simulated in the offline simulation environment and the operation path generated in the replicated offline simulation environment.

Specifically, for example, the adjustment unit 112 calculates a cycle time (for example, an average value, a variance value, or the like), the number of times of failures in path generation (for example, an average value, a variance value, or the like), the number of workpieces 50 that have been failed to be taken out (for example, an average value, a variance value, or the like), and the like, based on the operation of the robot 30 simulated in the offline simulation environment and the result of the operation path generated in the replicated offline simulation environment. Here, the number of times of failures in the path generation indicates, for example, the number of times when the robot 30 fails to take out the workpieces 50 in the operation path initially generated for taking out the workpiece 50 from above in the replication offline simulation environment, and the automatic path generation execution unit 111 changes the take-out position to another take-out position such as the side of the workpiece 50, or changes the target of the workpiece 50 to another workpiece 50.

The adjustment unit 112 compensates for the robot program such as the speed of the robot 30 and the compensation/addition of the take-out position based on the calculated cycle time, the number of times of failures in the path generation, the number of workpieces 50 that have been failed to be taken out, and the like. In addition, the adjustment unit 112 changes an algorithm used for automatic path generation and adjusts parameters for path generation, such as a distance to an obstacle such as the container 60 of a peripheral device (not illustrated), based on the calculated cycle time, the number of times of failures in the path generation, the number of workpieces 50 that have been failed to be taken out, and the like. The adjustment unit 112 stores the compensated robot program and the adjusted parameters for path generation in the storage unit 12.

In addition, the adjustment unit 112 may display the calculated cycle time, the number of times of failures in the path generation, the number of workpieces 50 that have been failed to be taken out, and the like on a display device (not shown) such as a liquid crystal display included in the offline simulation device 10.

The output unit 113 outputs the compensated robot program and the adjusted parameters for path generation to the robot control device 20.

With such a configuration, it is possible for the robot control device 20 to adjust the robot 30 in the real space in a short time by using the compensated robot program and the adjusted parameters of the path generation in the offline simulation.

### <Offline Processing of Offline Simulation Device 10>

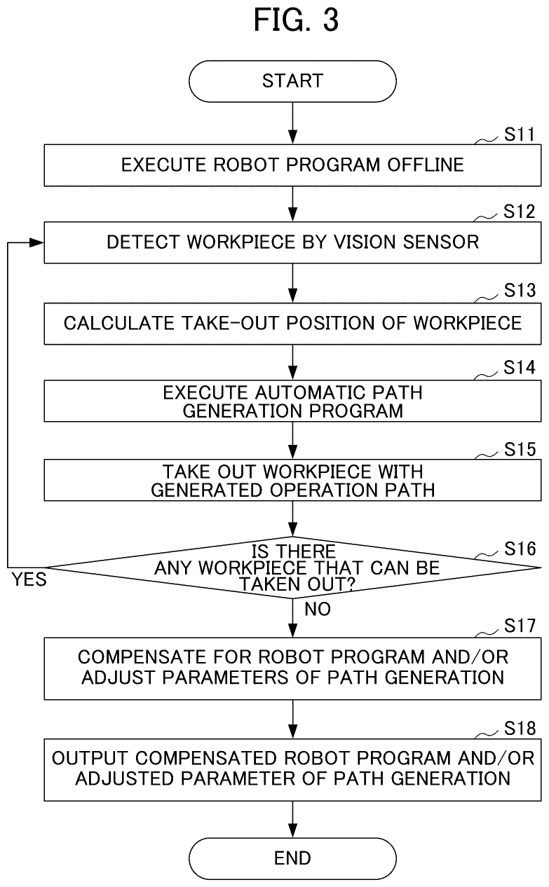

Next, an offline processing flow of the offline simulation device 10 will be described with reference to FIG. 3.

FIG. 3 is a flowchart showing offline processing of the offline simulation device 10. The flow shown here is executed every time the offline simulation device 10 receives an execution instruction of the robot program offline from the user.

In step S11, the offline program execution unit 110 executes the robot program when receiving an instruction to execute the robot program offline from the user via an input device (not shown) of the offline simulation device 10.

In step S12, the vision sensor 40 in the offline simulation environment images the container 60 to generate a virtual image, and detects the workpieces 50 from the generated image.

In step S13, the offline program execution unit 110 calculates the positions of the workpieces 50 detected in step S12 based on the virtual image generated in step S12, and outputs a path generation request including the positional information of the calculated position to the automatic path generation execution unit 111.

In step S14, when receiving the path generation request, the automatic path generation execution unit 111 executes the automatic path generation program, copies the offline simulation environment, and generates the operation path of the robot 30 in the replicated offline simulation environment obtained by copying.

In step S15, the offline program execution unit 110 causes the robot 30 to operate in the offline simulation environment based on the operation path generated in step S14, and takes out the workpieces 50.

In step S16, the offline program execution unit 110 determines whether or not there remains any workpiece 50 that still can be taken out based on detection performed by the vision sensor 40 in the offline simulation environment. If there is a workpiece 50 that can be taken out, the processing returns to step S12. On the other hand, when there is no workpiece 50 that can be taken out, the processing proceeds to step S17.

In step S17, the adjustment unit 112 compensates for the robot program and/or adjusts the parameters of the operation path based on the operation of the robot 30 simulated in the offline simulation environment and the result of the operation path generated in the replicated offline simulation environment.

In step S18, the output unit 113 outputs the compensated robot program and the adjusted parameters for path generation to the robot control device 20.

As described above, the offline simulation device 10 according to the first embodiment executes the robot program in the offline simulation environment in which the robot 30, the plurality of workpieces 50, and the vision sensor 40 are arranged in the virtual space, and simulates the operation of the robot 30 taking out the workpieces 50. In addition, the offline simulation device 10 copies the offline simulation environment and generates an operation path of the robot 30 in the replicated offline simulation environment obtained by copying. With such a configuration, it is possible for the offline simulation device 10 to simultaneously execute the operation of the robot by executing the robot program and the generation of the operation path of the robot by automatic path generation offline.

Further, the offline simulation device 10 outputs the compensated robot program and/or the adjusted parameters of the operation path to the robot control device 20 based on the operation of the robot 30 simulated in the offline simulation environment and the operation path generated in the replicated offline simulation environment. With such a configuration, it is possible for the robot control device 20 to adjust the robot 30 in the real space in a short time by using the compensated robot program and the adjusted parameters of the path generation in the offline simulation.

The first embodiment has been described above.

### Second Embodiment

Next, a second embodiment will be described. In the first embodiment, the offline simulation device 10 executes a robot program in an offline simulation environment in which a robot, a plurality of piled workpieces to be taken out by the robot, and a vision sensor that detects the plurality of workpieces are arranged in a virtual space, and simulates an operation of the robot to take out the workpieces. Further, the offline simulation device 10 copies the offline simulation environment and generates an operation path of the robot in the replicated offline simulation environment. On the other hand, in the second embodiment, an offline simulation device 10A is different from the first embodiment in that the offline simulation device 10A stores an execution state of a robot program and an execution state of generation of an operation path by using one offline simulation environment in which a robot, a plurality of piled workpieces to be taken out by the robot, and a vision sensor that detects the plurality of workpieces are arranged in a virtual space.

With such a configuration, according to the second embodiment, it is possible for the offline simulation device 10A to simultaneously execute the operation of the robot by executing the robot program and the generation of the operation path of the robot by automatic path generation offline. Hereinafter, the second embodiment will be described.

The robot system 100 according to the second embodiment includes the offline simulation device 10A, the robot control device 20, the robot 30, the vision sensor 40, the plurality of workpieces 50, and the container 60, as in the case of the first embodiment in FIG. 1.

### <Offline Simulation Device 10A>

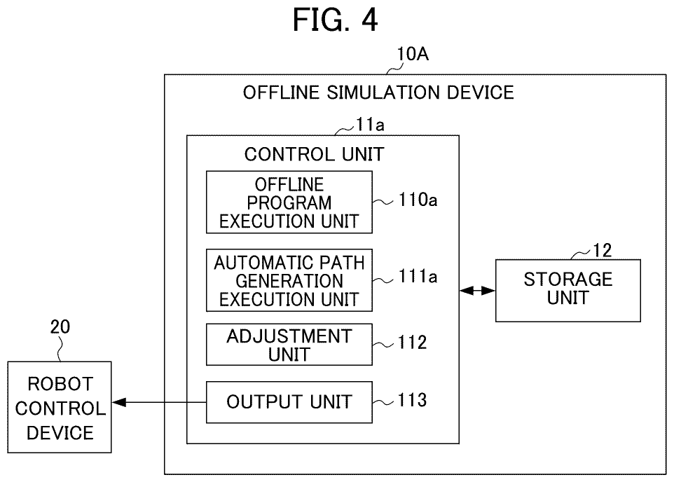

FIG. 4 is a functional block diagram showing a functional configuration example of the offline simulation device 10A according to the second embodiment. Components having the same functions as those of the offline simulation device 10 in FIG. 2 are denoted by the same reference numerals, and detailed descriptions thereof are omitted.

Similarly to the offline simulation device 10 according to the first embodiment, the offline simulation device 10A includes a control unit 11a and the storage unit 12. The control unit 11a includes an offline program execution unit 110a, an automatic path generation execution unit 111a, the adjustment unit 112, and the output unit 113.

The storage unit 12 has the same function as the storage unit 12 in the first embodiment.

<Control Unit 11a>

The control unit 11a includes a CPU, ROM, RAM, CMOS memory, and the like, which are configured to communicate with each other via a bus, and are known to those skilled in the art.

The CPU is a processor that generally controls the offline simulation device 10A. The CPU reads the system program and the application program stored in the ROM via the bus, and controls the entire offline simulation device 10A in accordance with the system program and the application programs. Accordingly, as illustrated in FIG. 4, the control unit 11a is configured to realize the functions of the offline program execution unit 110a, the automatic path generation execution unit 111a, the adjustment unit 112, and the output unit 113.

The adjustment unit 112 and the output unit 113 have the same functions as the adjustment unit 112 and the output unit 113 in the first embodiment.

Similarly to the offline program execution unit 110 of the first embodiment, for example, the offline program execution unit 110a executes a robot program in an offline simulation environment in which the robot 30, the vision sensor 40, the workpiece 50, and the container 60 are arranged in the virtual space, and simulates the operation of the robot 30 taking out the workpieces 50.

When executing the robot program offline, the offline program execution unit 110a stores the execution state of the robot program in the offline simulation environment in a preset storage area of the storage unit 12. Then, the offline program execution unit 110a simulates the operation of the robot 30 taking out the workpieces 50 with reference to the execution state of the robot program in the offline simulation environment stored in the storage unit 12.

The automatic path generation execution unit 111a generates an operation path of the robot 30 in the offline simulation environment, similarly to the automatic path generation execution unit 111 of the first embodiment.

When the automatic path generation execution unit 111a executes the automatic path generation program offline to generate the operation path, the automatic path generation execution unit 111a stores the execution state of the generation of the operation path in the offline simulation environment in a storage area different from the storage area of the preset offline program execution unit 110a of the storage unit 12. Then, the automatic path generation execution unit 111a references the execution state of the generation of the operation path in the offline simulation environment. stored in the storage unit 12, and generates the operation path of the robot 30 that takes out the workpieces 50.

With such a configuration, it is possible for the offline simulation device 10A to simultaneously execute the operation of the robot by executing the robot program and the generation of the operation path of the robot by automatically generating the path offline.

### <Offline Processing of Offline Simulation Device 10A>

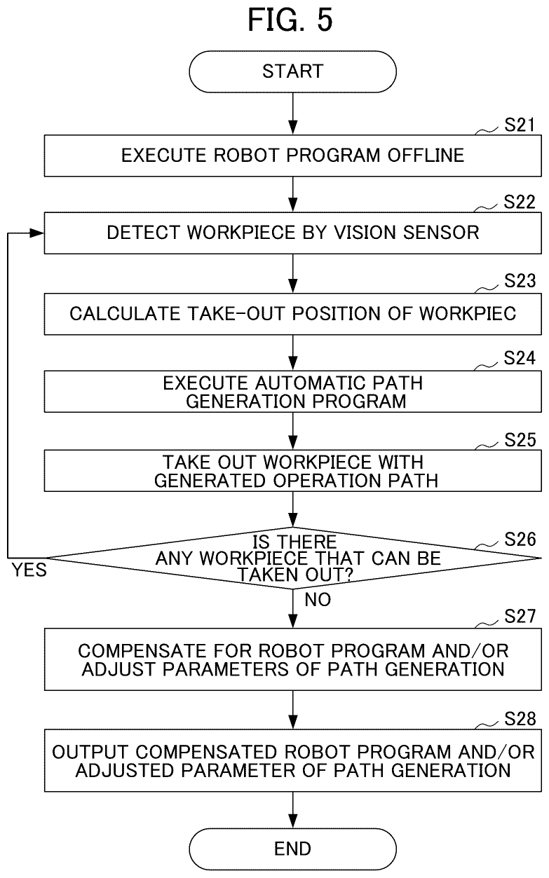

Next, an offline processing flow of the offline simulation device 10A will be described with reference to FIG. 5.

FIG. 5 is a flowchart showing offline processing of the offline simulation device 10A. The flow shown here is executed every time the offline simulation device 10A receives an execution instruction of the robot program offline from the user,

The processing of steps S26 to S28 are the same as the processing of steps S16 to S18 in FIG. 3, and thus the descriptions thereof will be omitted.

In step S21, when receiving an execution instruction of the robot program offline from the user via an input device (not shown) of the offline simulation device 10A, the offline program execution unit 110 executes the robot program and stores the execution state of the robot program in the offline simulation environment in the storage unit 12.

In step S22, the vision sensor 40 in the offline simulation environment references the execution state of the robot program in the offline simulation environment stored in the storage unit 12, generates a virtual image by imaging the container 60, and detects the workpieces 50 from the generated image.

In step S23, the offline program execution unit 110a calculates the position of the workpiece 50 detected in step S22 based on the virtual image generated in step S22, and outputs a path generation request including the positional information of the calculated position to the automatic path generation execution unit 111a.

In step S24, when receiving the path generation request, the automatic path generation execution unit 111a executes the automatic path generation program with reference to the execution state of the path generation in the offline simulation environment stored in the storage unit 12, and generates the operation path of the robot 30 in the offline simulation environment. The automatic path generation execution unit 111a stores, in the storage unit 12, the execution state of the generation of the operation path in the offline simulation environment.

In step S25, the offline program execution unit 110a causes the robot 30 to operate in the offline simulation environment based on the operation path generated in step S24, and takes out the workpieces 50. Then, the offline program execution unit 110a stores, in the storage unit 12, the execution state of the robot program in the offline simulation environment.

As described above, the offline simulation device 10A according to the second embodiment stores the execution state of the robot program and the execution state of the generation of the operation path using one offline simulation environment in which the robot 30, the plurality of workpieces 50, and the vision sensor 40 are arranged in the virtual space. The offline simulation device 10A executes the robot program offline and simulates the operation of the robot 30 taking out the workpieces 50 in the offline simulation environment by referencing to the execution state of the stored robot program. In addition, the offline simulation device 10A references the stored execution state of the generation of the operation path, and generates the operation path of the robot 30 in the offline simulation environment. With such a configuration, it is possible for the offline simulation device 10A to simultaneously execute the operation of the robot by executing the robot program and the generation of the operation path of the robot by the automatic path generation offline.

Further, the offline simulation device 10A outputs the compensated robot program and/or the adjusted parameters of the operation path to the robot control device 20 based on the operation of the robot 30 simulated in the offline simulation environment and the operation path generated in the replicated offline simulation environment. With such a configuration, it is possible for the robot control device 20 to adjust the robot 30 in the real space in a short time by using the compensated robot program and the adjusted parameters of the path generation in the offline simulation.

The second embodiment has been described above,

As described above, it is possible for the offline simulation devices 10 and 10A of the present disclosure to simultaneously execute the operation of the robot by executing the robot program and the generation of the operation path of the robot by the automatic path generation offline, as described in the first embodiment and the second embodiment.

### <Modification 1>

In the first embodiment and the second embodiment, the robot 30 takes out the workpieces 50 piled in bulk, but the present invention is not limited thereto. For example, the robot 30 may be included in a depalletization system that takes out stacked cardboard boxes or the like.

### <Modification 2>

For example, in the first embodiment and the second embodiment, the offline simulation devices 10 and 10A are devices different from the robot control device 20, but are not limited thereto. For example, the offline simulation devices 10 and 10A may be included in the robot control device 20.

In addition, the functions included in the offline simulation devices 10 and 10A according to the first and second embodiments can be implemented by hardware, software, or a combination thereof. Here, being implemented by software indicates being implemented by a computer reading and executing a program.

The program may be stored and provided to the computer using various types of non-transitory computer readable media (non-transitory computer readable medium). Non-transitory computer readable media include various types of tangible storage media. Examples of the non-transitory computer readable medium include a magnetic recording medium (flexible disk, magnetic tape, and hard disk drive), a magneto-optical recording medium (for example, a magneto-optical disk), a CD-ROM (Read Only Memory), a CD-R, a CD-R/W, and semiconductor memory (for example, mask ROM, PROM (Programmable ROM), EPROM (Erasable PROM), flash ROM, and RAM). The program may also be provided to the computer by various types of temporary computer readable media (Transitory computer readable medium). Examples of transitory computer readable media include electrical, optical, and electromagnetic signals. The transitory compute readable medium may provide the program to the computer via a wired communication path such as an electrical wire and an optical fiber, or via a wireless communication path.

It should be noted that the steps describing the program recorded in the recording medium include, of course, processing that is performed in time series in that order, and processing that is not necessarily performed in time series, but are performed in parallel or individually.

Although the present disclosure has been described in detail, the present disclosure is not limited to the individual embodiments described above. Various additions, substitutions, modifications, partial deletions, and the like can be made to these embodiments without departing from the gist of the present disclosure or the gist of the present disclosure derived from the contents described in the claims and the equivalents thereof. These embodiments can also be implemented in combination. For example, in the above-described embodiments, the order of each operation and the order of each process are shown as an example, and are not limited thereto. The same applies to cases where numerical values or numerical expressions are used in the description of the above-described embodiment.

The following Supplementary Notes are further disclosed with respect to the above-described embodiments and modifications.

### (Supplementary Note 1)

The offline simulation device (10) includes: the offline program execution unit (110) configured to execute a robot program in an offline simulation environment in which the robot (30), the plurality of workpieces (50) piled to be taken out by the robot (30), and the vision sensor (40) that detects the plurality of workpieces (50) are arranged in a virtual space, and simulate an operation of the robot (30) taking out each of the plurality of workpieces (50), the automatic path generation execution unit (111) configured to copy the offline simulation environment and generate an operation path of the operation of the robot (30) in a replicated offline simulation environment obtained by copying, and the adjustment unit (112) configured to compensate for the robot program and/or adjust a parameter of the operation path based on a simulated operation of the robot (30) and a generated operation path.

### (Supplementary Note 2)

The offline simulation device (10A) includes: the offline. program execution unit (110a) configured to execute a robot program in an offline simulation environment in which the robot (30), the plurality of workpieces (50) piled to be taken out by the robot (30), and the vision sensor (40) that detects the plurality of workpieces (50) are arranged in a virtual space, and simulate an operation of the robot (30) taking out each of the plurality of workpieces (50), the automatic path generation execution unit (111a) configured to generate an operation path of the operation of the robot (30) in the offline simulation environment, the storage unit (12) configured to store an execution state of the robot program in the offline simulation environment by the offline program execution unit (110a) and an execution state of generation of the operation path in the offline simulation environment by the automatic path generation execution unit (111a), and the adjustment unit (112) configured to compensate for the robot program and/or adjust a parameter of the operation path based on a simulated operation of the robot (30) and a generated operation path.

### (Supplementary Note 3)

In the offline simulation device (10, 10A) as described in Supplementary Note 1 or Supplementary Note 2, the plurality of workpieces (50) are a plurality of workpieces piled in bulk or a plurality of workpieces of a depalletization system.

### (Supplementary Note 4)

In the offline simulation device (10, 10A) as described in Supplementary Note 1 or Supplementary Note 2, the adjustment unit (112) calculates at least a cycle time and the number of times of failures in generating the operation path based on the simulated operation of the robot (30) and the generated operation path.

### (Supplementary Note 5)

In the offline simulation device (10, 10A) as described in Supplementary Note 4, when the plurality of workpieces (50) are piled in bulk, the adjustment unit (112) calculates the cycle time, the number of times of failures in generating the operation path, and the number of workpieces (50) that have been failed to be taken out, based on the simulated operation of the robot (30) and the generated operation path.

### (Supplementary Note 6)

The offline simulation device (10, 10A) as described in Supplementary Note 1 or Supplementary Note 2 further includes the output unit (113) configured to output a compensated robot program and/or an adjusted parameter of the operation path to the robot control device (20) in a real space.

### EXPLANATION OF REFERENCE NUMERALS

10, 10A Offline simulation device
11, 11a Control unit
110, 110a Offline program Execution unit
111, 111a Automatic path generation execution unit
112 Adjustment unit
113 Output unit
20 Robot control unit
30 Robot
31 Take-out hand
40 Vision sensor
50 Workpiece
60 Container

1. An offline simulation device comprising:
an offline program execution unit configured to execute a robot program in an offline simulation environment in which a robot, a plurality of workpieces piled to be taken out by the robot, and a vision sensor that detects the plurality of workpieces are arranged in a virtual space, and simulate an operation of the robot taking out each of the plurality of workpieces;
an automatic path generation execution unit configured to copy the offline simulation environment and generate an operation path of the operation of the robot in a replicated offline simulation environment obtained by copying; and
an adjustment unit configured to compensate for the robot program and/or adjust a parameter of the operation path based on a simulated operation of the robot and a generated operation path.

2. An offline simulation device comprising:
an offline program execution unit configured to execute a robot program in an offline simulation environment in which a robot, a plurality of workpieces piled to be taken out by the robot, and a vision sensor that detects the plurality of workpieces are arranged in a virtual space, and simulate an operation of the robot taking out each of the plurality of workpieces;
an automatic path generation execution unit configured to generate an operation path of the operation of the robot in the offline simulation environment;
a storage unit configured to store an execution state of the robot program in the offline simulation environment by the offline program execution unit and an execution state of generation of the operation path in the offline simulation environment by the automatic path generation execution unit; and
an adjustment unit configured to compensate for the robot program and/or adjust a parameter of the operation path based on a simulated operation of the robot and a generated operation path.

3. The offline simulation device according to claim 1, wherein the plurality of workpieces are a plurality of workpieces piled in bulk or a plurality of workpieces of a depalletization system.

4. The offline simulation device according to claim 1, wherein the adjustment unit calculates at least a cycle time and a number of times of failures in generating the operation path, based on the simulated operation of the robot and the generated operation path.

5. The offline simulation device according to claim 4, wherein, when the plurality of workpieces are piled in bulk, the adjustment unit calculates the cycle time, the number of times of failures in generating the operation path, and a number of workpieces that have been failed to be taken out, based on the simulated operation of the robot and the generated operation path.

6. The offline simulation device according to claim 1, further comprising an output unit configured to output a compensated robot program and/or an adjusted parameter of the operation path to a control unit in a real space.
